(19) United States
(12) Patent Application Publication
(10) Pub. No.: US 2026/0237910 A1
(43) Pub. Date: Aug. 13, 2026

(54) CALCULATING PHASE AND GAIN PARAMETERS TO CONTROL ANTENNAS FOR A SPECIFIED SPATIAL FILTER

(71) Applicant: INTERNATIONAL BUSINESS MACHINES CORPORATION, ARMONK, NY (US)

(72) Inventors: BODHISATWA SADHU, Peekskill, NY (US); Arun Paidimarri, South Salem, NY (US)

(21) Appl. No.: 19/049,531

(22) Filed: Feb. 10, 2025

(51) Int. Cl. H01Q 15/00; H01Q 3/30; H04B 1/40; H04B 7/0426

(52) U.S. Cl. CPC H01Q 15/0053; H01Q 3/30; H04B 1/40; H04B 7/043

(57) ABSTRACT

Provided are a method, phased array system, and integrated circuit for calculating phase and gain parameters to control antennas for a specified spatial filter. Front-end units receive weights, and phase slope parameters for component beams. A front-end unit of the front-end units calculates a phase shift and gain parameters for an antenna controlled by the front-end unit based on the phase slope parameters, the weights, and a physical location of the antenna controlled by the front-end unit.

### BACKGROUND OF THE INVENTION

### 1. Field of the Invention

The present invention relates to a computer implemented method, system, and integrated circuit for calculating phase and gain parameters to control antennas for a specified spatial filter.

### 2. Description of the Related Art

A phased array system may include a beam forming integrated circuit (IC) and a plurality of antennas. The phased array system may use a plurality of antenna signal paths, where each antenna signal path may have a variable time delay and/or phase and/or gain. For phased array systems being implemented as receivers (or receiver channels in a transceiver), the beam forming circuit may use propagation delay and/or phase produced by the variable time delay, and/or phase shifts produced by variable phase shifters and/or gain produced by variable gain amplifiers in each antenna signal path of signals being received by the phased array so that higher receiver gain is achieved for signals arriving from a specific direction. For phased array systems being implemented as transmitters (or transmission channels in a transceiver), the beam forming circuit may control time delay and/or phase shifts and/or gain for each antenna signal paths of the plurality of antennas to generate an electromagnetic beam having specific direction. The beam forming IC may subsequently change the time delays and/or phase shifts and/or gains to steer the electromagnetic beam to different directions.

A phased array may apply a set of time delay, and/or phase shift and/or gain at each of its antennas to create a specific spatial pattern of gains in space. Such a spatial pattern can be called a spatial filter or a beam. As an example, a linear one-dimensional array of antennas can produce a one-dimensional control of gains in space, for example along the azimuth or elevation, while a 2-dimensional array of antennas can produce two-dimensional spatial filter control in both azimuth and elevation.

### SUMMARY

Provided are a method, phased array system, and integrated circuit for calculating phase and gain parameters to control antennas for a specified spatial filter. Front-end units receive weights, and phase slope parameters for component beams. A front-end unit of the front-end units calculates a phase shift and gain parameters for an antenna controlled by the front-end unit based on the phase slope parameters, the weights, and a physical location of the antenna controlled by the front-end unit.

### BRIEF DESCRIPTION OF THE DRAWINGS

FIG. 1 is an embodiment of a system to implement a spatial filter synthesis.

FIG. 2 is an embodiment of a calculator circuit in a front-end unit for an antenna to process phase slope and weight parameters for beams.

FIG. 3 illustrates an embodiment of operations to generate phase slope and weight parameters for beams of a selected spatial filter.

FIG. 4 illustrates an embodiment of operations at front-end units for antennas to process the phase slope and weight parameters for the spatial filter to generate the control signals to control an antenna.

FIG. 5 illustrates an embodiment of operations to calculate phase shift and gain parameters from the received phase slope and weight parameters for the spatial filter.

### DETAILED DESCRIPTION

A phased array antenna system is commonly deployed in wireless communication networks and sensing systems. Such wireless communications system could include fifth generation (5G) wireless communications system, satellite communication system, point-to-point communications systems such as common data link, and/or other types of wireless communication networks. Sensing systems could include automotive radars, gesture recognition systems, satellite sensing. Phased array antenna systems can also be deployed for joint communications and sensing or integrated sensing and communications. The phased array processes a spatial filter comprising a beam specification that results in beams with specific shape and attributes, such as phase, gain, direction. A signal with different phase and gain are applied at each of the antennas in the phased array in order to generate the desired beam, or spatial filter, or a spatial distribution of signal energy.

Described embodiments provide improvements to phased array technology by providing improved technology for performing the spatial filter synthesis in a beamformer integrated circuit. Specifically, the embodiments enable fast creation and switching of arbitrarily shaped beams. Storing all possible arbitrary beam shapes in memory is prohibitive in terms of memory. Thus, traditional beam table approaches require a transfer of a large number of parameters (the phases and gains for each antenna element) in order to update a beam table entry. Instead, embodiments locally calculate the phases and gains for each antenna using fewer parameters that are all common to all the antennas, enabling the parameters to be broadcast to all front-end units. The desired spatial filter is first decomposed into component linear-phase-slope beams (sinc-shaped beams), each with a weight. The weights and phase slopes for each component beam, such as a linear-phase-slope beam, are the parameters broadcast to all the beamformer integrated circuits, The beamformer integrated circuit includes a plurality of front-end units that concurrently form the composite beam. Each front-end unit includes a plurality of calculators that concurrently compute the phase and gain for each component beam from the slope parameters. Then, each front-end unit applies the weights to compute the phase and gain parameters for the composite beam. The final beam formed from the phase and gain from each of the front-end units is designed to closely approximate the desired spatial filter.

Described embodiments provide optimizations at multiple levels. At the calculator level within the front-end units, processing is optimized by having calculators in each of the front-end units concurrently execute to generate the component beams that will be combined in the front-end units. Further, processing is optimized at the beamformer integrated circuit level by having each front-end unit concurrently execute to concurrently generate the phase and gain for each of the antennas to form the desired beam specified by the spatial filter.

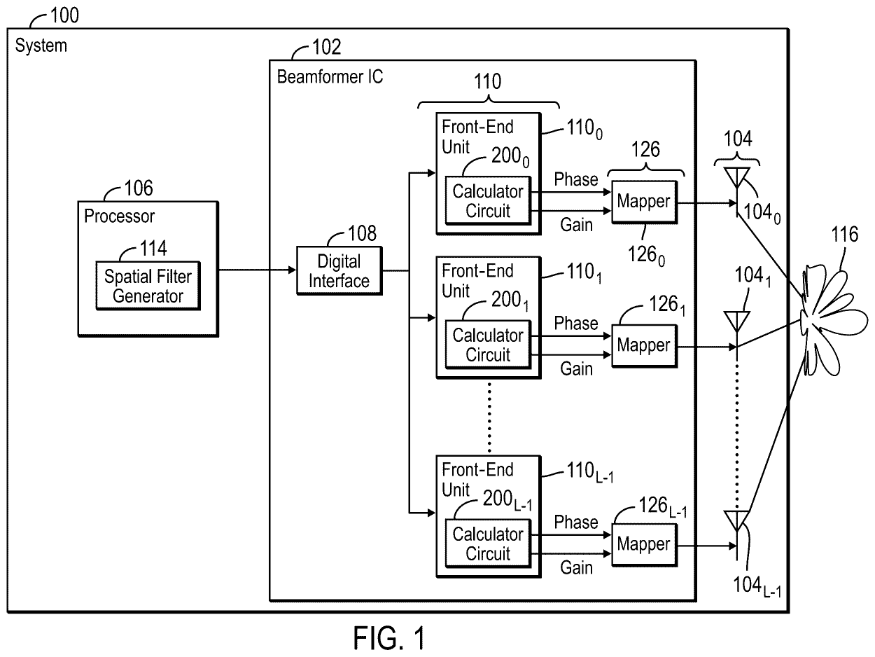

FIG. 1 illustrates an embodiment of a system to implement a spatial filter with spatial filter synthesis. The system 100 may be a radio frequency (RF) transmission system implemented by a communication device, such as a RF transmitter, a RF receiver, or a RF transceiver. The system 100 may be configured to operate at common wireless radio frequencies, millimeter-wave frequencies, and/or microwave frequencies. The system 100 may be a part of a wireless communication network, such as, but not limited to, fourth generation (4G) wireless communications system, fifth generation (5G) wireless communications system, satellite communication system, point-to-point communications systems such as common data link, and/or other types of wireless communication networks. The system 100 may be part of a RF transmitter or RF receiver for the purpose of sensing such as radar, imaging, etc.

The system 100 may include a beamformer integrated circuit (IC) 102, a plurality of antennas 104₀. . . 104_{L-1} forming a phased array of antennas 104, and a processor 106. The processor 106 may comprise a microcontroller, central processing unit (CPU), field-programmable gate array (FPGA) or any other circuitry implemented by semiconductor devices that is configured to perform at least some of the operations described herein. By way of example, processor 106 may be configured to perform various operations of system 100 off-chip (e.g., outside of beamformer IC 102). The beamformer IC 102 may be implemented in a single integrated circuit substrate or on multiple integrated circuit substrates.

Phased array systems, such as system 100, may create spatial filters (e.g., beam specifications that results in beams with specific shape and attributes such as phase, gain in each direction, or the like) by applying a signal with different phase and gain at each antenna in an antenna array. The resulting beam shape can have several important characteristics including the directions of peaks, beam gains at the peaks, beam widths, directions of nulls, sidelobe levels. In a given application, some of these characteristics are more important. For example, in a low-density communication system, only the peak gain and their direction are important. However, in case of a receiver operating in a dense environment, the peak gain and direction as well as the direction of nulls is important. Interference from specific directions are filtered out even when the interference is at the same frequency as the wanted signal and gain in the direction of the wanted signal may be increased while suppressing signals from unwanted directions. For a transmitter, the signal gain may be increased in the direction of the peak while interference to other users may be reduced by pointing nulls in these unwanted directions. Other use cases may include enabling advanced beam search algorithms to find the direction of the user and may enable advanced sensing by analyzing directional reflections. In each of these, a system controller can determine the set of beam specifications that are important.

The embodiments perform spatial filter synthesis by adding several component beams with corresponding weights. The component beams are linear phase slope beams. In some embodiments, the directions of the component beams are chosen such that the peak of each component beam occurs at the nulls of all other component beams. There is freedom in choosing the absolute direction for one of the component beams. Once one direction is chosen, all the other orthogonal directions are fixed, for example by the directions of the nulls of the beam.

The weights applied to each component beam define the gain of the spatial filter at the peak direction of the component beam. Because all other component beams present nulls at the peak of the given component beam, each weight only affects the spatial gain at one of the orthogonal directions. However, the weights, including their amplitude and phase, can affect the shape of the spatial filter in the directions between the orthogonal directions.

The directions of the component beams can be considered as a set of orthogonal directions. For a 1-dimensional array with L antennas, there may be L-1 orthogonal directions. As such, the plurality of antennas 104 may include L antennas, such as antennas 104₀ to 104_{L-1}. Each antenna among the antennas 104 may output an RF signal having a respective amplitude and phase. And for a 2-dimensional array with L*P antennas, there are (L-1)*(P-1) orthogonal directions. In some embodiments, the directions of the component beams and their weights are chosen through an optimization algorithm. In these embodiments, the component beams may not have the directions of peaks coincide with the direction of nulls for the other component beams.

The beamformer IC 102 may include a digital interface 108 coupled to L front-end circuits 110₀, 110₁. . . 110_{L-1}. Each front-end circuit 110ₗ, where l denotes any of the front-end circuits 110, may include a respective set of components, such as power amplifiers, variable gain amplifiers (VGA), phase shifters, and/or other types of components. Each of the front-end units 110ₗ includes a calculator circuit 200₀, 200₁. . . 200_{L-1} to calculate a phase and gain from slope parameters, e.g., the X-Y slope parameters, and weights for each of the beams of a set of component beams for a spatial filter.

In certain embodiments, the L front-end units can be split into multiple integrated circuits (ICs). In such embodiments, the processor 106 communicates with the digital interfaces of all the ICs through either one common bus or the communication can be split into multiple buses. Within each IC, in certain embodiments, the calculator circuits 200₀, 200₁. . . 200_{L-1} may be implemented as a common shared calculator circuit.

The processor 106 may include a spatial filter generator 114 to generate the slope parameters and an amplitude weight for each slope parameter used to generate the component beams for a selected spatial filter. The defined slope parameters and weights may be used to generate the component beams that when added using the weights form a specific pattern, such as a wide beam, wide beam with nulls, stepped pattern, a narrower beam, etc. The spatial filter generator 114 may support a finite set of beam parameters for creating different spatial filters.

In the embodiment shown in FIG. 1, system 100 may generate beam 116 from a desired beam specified by a spatial filter with a given set of specifications. In certain embodiments, the spatial filter specifications may specify the complete shape of the desired beam to be formed by the phased array. In further embodiments, the specifications include a set of parameters of the beam that are most important, which may include peak directions, beam widths, null directions etc. The spatial filter generator 114 may sample the desired spatial filter in a set of orthogonal directions. For example, in a 1-D array of size L, there may be N=L-1 orthogonal directions. In a 2-D array of size L*P there may be N=(L-1)*(P-1) orthogonal directions. In certain embodiments, the sampled spatial filter values are weights for the N component beams. In further embodiments, the sampled values of the spatial filter may be transformed to compute the N weights for the component beams. Transformations include adding phases, amplification. In some embodiments, an optimization algorithm determines a set of directions for composite beams and the corresponding weights. The optimizer might target a set of objective specifications for the desired beam.

For each of the directions, the spatial filter generator 114 may compute phase slopes in the X and Y directions. In certain embodiments, the spatial filter generator 114 may apply a filtering process to reduce the number of parameters from N to the lower number K. In some embodiments, an optimizer takes the desired number of components beams K as an additional input. The K sets of parameters may be compressed, or the parameters may be quantized. The spatial filter generator 114 may also extract a set of static parameters including the L locations of L antennas 104 supported by each beamformer IC 102. The L antenna locations may be represented as a matrix that includes coordinates representing physical locations of each of the L antennas with respect to the entire phased array of system 100. The static parameters of the antenna locations (iₗ, j₁) may also be programmed, loaded from memory, or hardcoded.

The spatial filter generator 114 may broadcast the amplitude weights Wₖ and the K phase slope parameters to the beamformer IC 102. The front-end units 110 receive these parameters via the digital interface 108. Each front-end unit 110ₗ includes a calculator circuit 200ₗ to calculate the phase and gain based on the phase slope parameters, weights received and the antenna locations for the beams to form. In the embodiment shown in FIG. 1, each calculator circuit 200ₗ in the front-end units 110 may store an antenna location (iₗ, jₗ) of an l^{th} antenna to apply to each of the X-Y phase slopes. The variable l denotes an instance of a component, such as front-end unit 110ₗ, calculator circuit 200ₗ, and antenna 104ₗ, etc.

The calculator circuit 200ₗ calculates the phase and gain, and forwards the calculated phase and gain to a mapper 126ₗ of mappers 126₀. . . 126_{L-1}. The spatial filter generator 114 may configure the mappers 126, including circuits therein, to define mappings to map the desired gain and phase values to a phase shifter setting and variable gain amplifier (VGA) settings such that the gain and phase applied to the signal at the antenna is the desired value. As such, the entire phased array produces a beam or spatial filter that corresponds to the spatial filter configured by the spatial filter generator 114. In one embodiment, to perform the mapping, mapper 126ᵢ may include circuit components such as digital-to-analog converters (DAC), decoders, and other circuit components to convert desired phase value and gain value into a phase shifter setting and gain setting, respectively.

In certain embodiments, the phase shifter has no gain dependence and the VGA has no phase dependence, such that the mapper maps the phase to phase shifter settings and the gain to the VGA settings independently. In further embodiments, the mapping may be done taking into account the gain and phase dependence of the phase shifter and VGA. By way of example, the output phase value can indicate a phase angle of desired beam and the mapper 126ₗ can convert the phase angle indicated by the phase value into a digital code that sets a phase shifter accordingly. Further, mapper 126ₗ may include DACs that can convert the digital codes into analog voltages, or phase sifter settings, for controlling a phase shifter. In another example, the gain value can indicate a gain of desired beam and the mapper 126ₗ may include DACs that can convert the gain indicated by the gain value into an analog voltage that can control the gain of a VGA. As an example, the mapper 126ₗ may compensate for any non-idealities in the phase shifter and VGA. In an example, it may be unnecessary that a VGA and phase shifter be separate circuit components. The application of the gain setting and phase shifter setting may allow antennas 104 to output signals that form the desired beam 116.

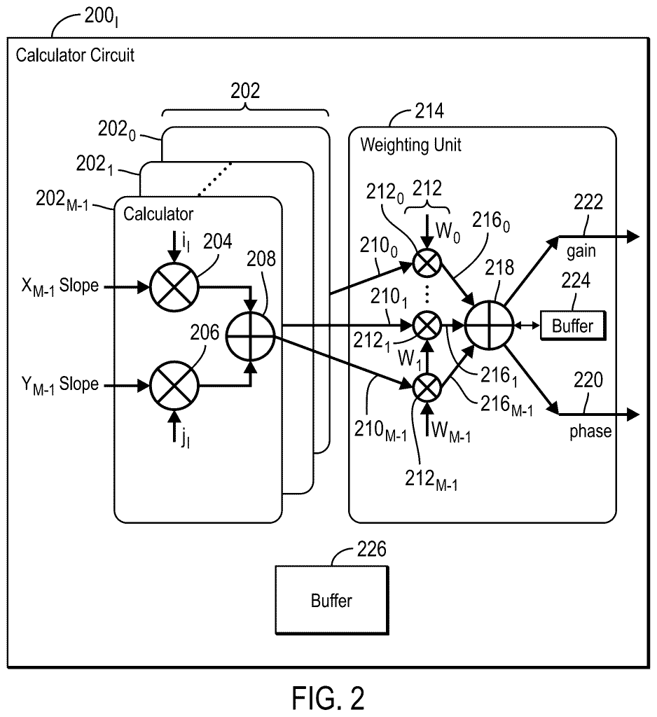

FIG. 2 illustrates an embodiment of the calculator circuit 200ₗ to calculate the phase and gain for antenna 104ₗ. The calculator circuit includes M calculators 202₀, 202₁. . . 202_{M-1}, each calculating the phase for one of M component beams for a front-end unit. The M calculators 202ₘ process M slope parameters from the spatial filter generator 114 along with the (iₗ, jₗ) location values of the l^{th} antenna 104ₗ for which the phase and gain values are being calculated. Each calculator 202ₘ, where m indicates any one of the calculators 202₀. . . 202_{M-1}, includes an X-multiplier 204 to multiply the received slope xₘ by the iₗ location value and a Y-multiplier 206 to multiply the received slope yₘ by the jₗ location value. The outputs of the multipliers 204, 206 are combined at the adder 208 to form a phase for a complex value 210ₘ or complex phasor with unit amplitude and the phase from the adder 208. In this way each calculator 202ₘ receives different phase slope values but uses the same location value to produce the outputs of the multipliers 204, 206.

The resulting complex phasors 210₀, 210₀...210_{M-1} from the 202ₘ calculators are then sent to corresponding multipliers 212₀, 212₀. . . 212_{M-1} in a weighting unit 214. The multipliers 212 multiply the complex phasors 210₀. . . 210_{M-1} by corresponding weights W₀. . . W_{M-1}1 to produce weighted phasor values 216₀. . . 216_{M-1} to combine at adder 218. In some embodiments, the output of this adder 218 is stored in a buffer 224. In certain embodiments, the value stored in the buffer 224 is passed as another input to adder 218.

In certain embodiments, the output of the adder 218 is converted to form the final phase shift 220 and gain 222 parameters to send to the corresponding mapper 126ₗ.

In certain embodiments, when the total number of phase slope and weight parameter K exceeds M, the number of calculators 202, output of the adder 218 is stored in buffer 224. The calculator 200ₗ further includes a second buffer 226. If the number of phase slope and weight parameters communicated by the spatial filter generator 114, or K, exceeds M, the number of calculators 202, then the calculator circuit 200ₗ may buffer the K-M phase slope and weight parameters in buffer 226 to later input into the M calculators. The output of the adder 218 is stored in buffer 224 until all K sets of phase slope and weight parameters are processed. Further, the buffer 226 may cache intermediary weighted phasor values and any other calculated values to reuse when the input phase slope and weight parameters for beams to generate for subsequent spatial filters are the same.

In the above described embodiments, there is a one-dimensional linear array of L antennas. In an alternative embodiment, the antennas may be arranged in a two-dimensional array of size L*P, of L columns of antennas and P rows of antennas resulting in a rectangular array of L*P antennas. In the case of the one-dimensional array, there may be 0 to (L-1) front-end units and mappers. In the case of the two-dimensional array, there may be 0 to (L*P-1) front-end units and mappers.

In the embodiment of FIG. 1, all of the front-end units are implemented in one beamformer integrated circuit substrate 102. In alternative embodiments, the front-end units may be implemented across multiple integrated circuit substrates or multiple beamformer ICs.

Processor 106 may be implemented as part of a microcontroller, central processing unit (CPU). In such embodiments, the spatial filter generator 114 may comprise code accessed by the processor 106 from memory to execute.

In further embodiments, the processor 106 and spatial filter generator 114 therein may be implemented in Application Specific Integrated Circuit (ASIC) hardware devices, Data Processing Units (DPUs), field-programmable gate array (FPGA) or any other circuitry implemented by semiconductor devices that is configured to perform at least some of the operations described herein.

The processor 106 can be configured to perform various operations of system 100 off-chip (e.g., outside of beamformer ICs 102).

The buffers 224 and 226 may each comprise one or more suitable volatile or non-volatile memory devices.

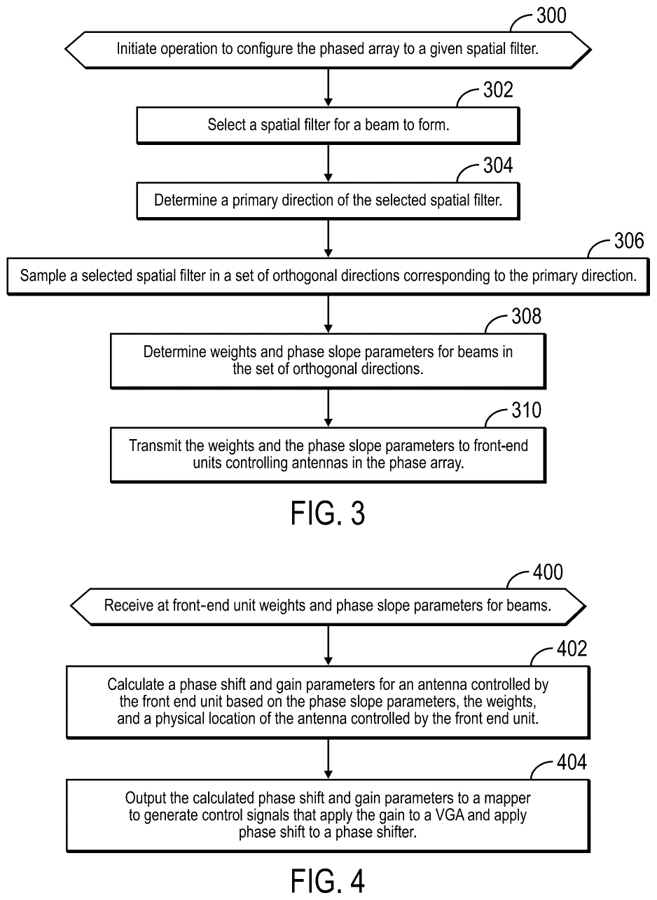

FIG. 3 illustrates an embodiment of operations performed by the spatial filter generator to generate the phase slope and weight parameters for the component beams for a selected spatial filter. In one embodiment, the phase slope and weight parameters may be generated by the spatial filter generator 114 executed by the processor 106 as shown in FIG. 1. Upon initiating (at block 300) an operation to configure the phased array to a given spatial filter, a spatial filter is selected (at block 302). A primary direction is determined (at block 304) of the selected spatial filter. The primary direction selection determines the directions of the other orthogonal directions. In certain embodiments, the primary direction is the direction of the most critical specification of the spatial filter. The selected spatial filter is sampled (at block 306) in a set of orthogonal directions corresponding to the primary directions. Weights and phase slope parameters are determined (at block 308) for beams in the set of orthogonal directions. The determined weights and phase slope parameters are transmitted (at block 310) to front-end units controlling antennas in the phased array to generate the control signals to control the antennas.

In certain embodiments, the spatial filter generator selects a subset of the component beams to be sent to the front-end units. In further embodiments, the weights for the selected subset of the component beams are quantized to reduce the communication to the front-end units. In yet further embodiments, compression algorithms may be applied to the information to be sent to the front-end units. Compression reduces the time required to communicate the weights and phase slope parameters, allowing the overall time required to switch the phased array's output beam/spatial filter. For example, if there are N orthogonal beam directions for the component beams, the spatial filter generator may select K beam directions to communicate with the front-end units. In a linear phased array with L antennas, N=(L-1). In a two-dimensional phased array with L*P antennas, N=(L-1)*(P-1). In some embodiments, the set of directions for the component beams and corresponding weights are computed using an optimization algorithm that targets a set of specifications for the composite beam.

FIG. 4 illustrates an embodiment of operations to generate the phase shift and gain parameters to control an antenna. In certain embodiments, the operations of FIG. 4 may be performed simultaneously in multiple front-end units 110 receiving the phase slope and weight parameters to control the antennas to form beams in the set of component beam directions for the selected spatial filter. Upon receiving (at block 400) at a front-end unit the weights and phase slope parameters for the beams, a phase shift and gain parameters are calculated (at block 402) for an antenna controlled by the front-end unit based on the received phase slope parameters, the weights, and a physical location of the antenna controlled by the front-end unit. A calculated phase shift and gain parameters are outputted (at block 404) to a mapper, such as mapper 126, to generate the control signals that apply the gain to a VGA and apply the phase shift to a phase shifter. As a result, the antennas output signals that cause the phased array to form the desired beam.

With the embodiment of FIG. 4, the phase slope and weight parameters for all the component beams are processed to generate the phase and gain control signals for a single antenna. For each component beam, the phase parameter is calculated by scaling the phase slopes in the X and Y direction by the location of the antenna in the X and Y direction, and adding them. For example, for the phase for the l^{th} antenna for the k^{th} component beam, phase_{l,k}=slope_xₖ*iₗ+slope_yₖ*jₗ, where iₗ and jₗ are the locations of the l^{th} antenna in the x and y directions respectively. The component beams are linearly combined with the weights to generate the phase and gain values for the antenna. For example, if there are K component beams selected by the processor, the complex gain for the l^{th} antenna is gₗ∠phaseₗ=Σwₖ∠phase_{l,k}, where the summation is over the K component beams. The resulting gain gₗ and phaseₗ are applied to a mapper that then generates the control settings for the VGA and/or phase shifter in the front-end. This enables simple on-chip calculations at the front-end units for the antennas based on the phase slope and weight parameters for the spatial filter calculated off-chip at the processor by the spatial filter generator. All the front-end units may perform the computations in parallel.

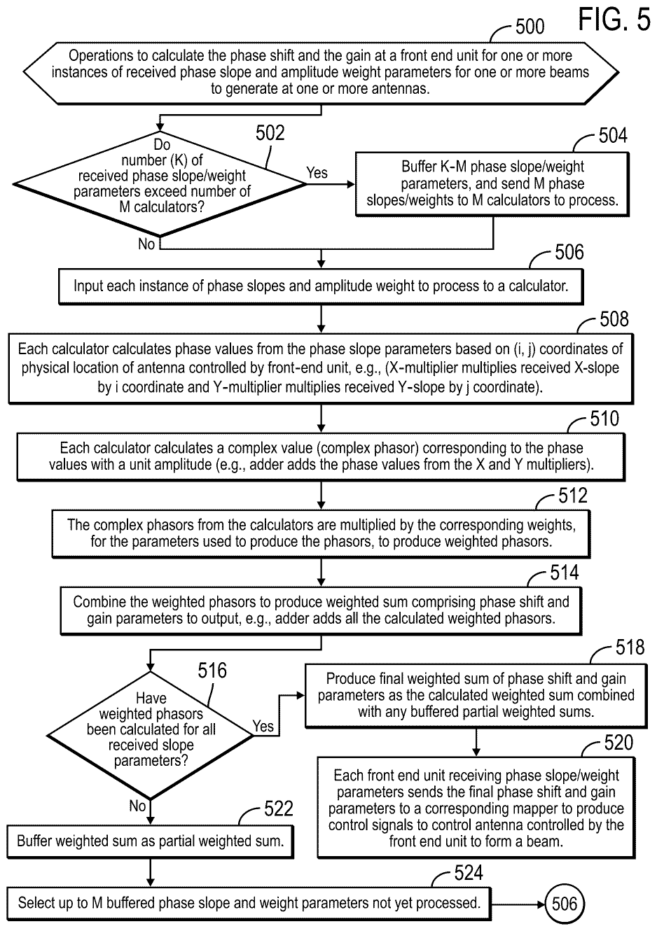

FIG. 5 illustrates an embodiment of the operations at step 402 in FIG. 4 to calculate the phase shift and gain parameters for a single antenna based on the combined slopes and weights for all the component beams. In certain embodiments, the operations of FIG. 5 may be performed at each of a plurality of the front-end units 110 and calculator circuits 200ₘ therein, including the M calculators 202 and weighting unit 214, to form weighted phasors from all the beams to combine to produce the gain and phase parameters for the single antenna controlled by the front-end unit. Operations are initiated (at block 500) to calculate the phase shift and the gain at a front-end unit for one or more instances of a received phase slope and amplitude weight parameters for one or more component beams to be combined to generate the phase and gain settings for one or more antennas. If (at block 502) the number of received phase slope/weight parameters K exceed the number of M calculators, then K-M phase slope/weight parameters may be buffered (at block 504) at buffer 226 and M of the slopes/weights are sent to M calculators to process. If (from the NO branch of block 502) K is less than M or from block 504, each instance of the X-Y slopes and amplitude weights received are inputted (at block 506) to a calculator, or one or more of the M calculators. In this way each instance of X-Y slopes and weight are simultaneously processed by a different calculator.

In certain embodiments, the parameters from the spatial filter generator are communicated to the front-end units in a serial manner. Further, the serial communication may lead to the parameters being received in batches. In such a scenario, each batch of parameters are sent to the calculators. Each batch K_{batch} is treated similar to how K is treated above. In further embodiments, the compression, quantization applied to the parameters causes K_{batch}>M and in yet further embodiments, K_{batch}<M. Still further, the weights for all unused component beams in any calculation step may be made 0.

Each calculator receiving parameters calculates (at block 508) phase values from the phase slope parameters based on the (i, j) coordinates of the physical location of the antenna controlled by the receiving front-end unit. In one embodiment, an X-multiplier multiplies the received X-slope by the i coordinate and the Y-multiplier multiplies received Y-slope by j coordinate. In one embodiment, an adder in each calculator may add the phase values from the X and Y multipliers to form the complex phasor. For example, for the phase for the lth antenna for the kth component beam, phase_{l,k}=slope_x_{k*}iₗ+slope_yₖ*jₗ, where iₗ and jₗ are the locations of the l^{th} antenna in the x and y directions respectively.

Each calculator then calculates (at block 510) a complex value (complex phasor) corresponding to the phase values with a unit amplitude. This complex phasor is 1∠phase_{l, m} for the l^{th} front-end unit's m^{th} calculator. The complex phasors from the calculators are multiplied (at block 512) by the corresponding weights wₘ for the mth component beam being computed. The weighted phasors are combined (at block 514) to produce a weighted sum comprising phase shift and gain parameters.

In one embodiment, an adder may combine all the calculated weighted phasors to produce the phase shift and gain parameters. In certain embodiments, the multiplier used for weighting is included in the calculator circuits 202 with just an adder in the weighting unit 214. If K<M, the output of the adder is the final complex gain (phase and gain) that is then passed to the mapper for the front-end. If not all K component beams have been calculated, then the adder output is a partial addition. In some embodiments, the adder also adds the previous partial addition in order to create the total partial addition of all component beams computed so far.

If (at block 516) all weighted phasors have been calculated for all the received slope parameters, then a final weighted sum of phase shift and gain parameters is produced (at block 518) as the calculated weighted sum. This would be the sum of the stored partial sum in 224 and the weighted sum of the last M computed beams. If there are no partial weighted sums buffered, that is, the partial sum in 224 is 0, then the final weighted sum is just the weighted sum of the M component beams. This occurs for the first M beams when K>M or when K<M. Each front-end unit receiving phase slope/weight parameters sends (at block 520) the final phase shift and gain parameters to a corresponding mapper to produce control signals to control the antenna controlled by the front-end unit to form a beam according to the selected spatial filter.

If (at block 516) all weighted phasors have not been calculated for all the received slope parameters, then the weighted sum calculated at block 514 is saved (at block 522) in the buffer 224 as a partial weighted sum. Selection is made (at block 524) of M or less remaining buffered slope parameters and weights that have not yet been processed. In certain embodiments, some of these parameters may be newly arrived parameters from the digital interface. Control then proceeds back to block 506 to process the selected buffered phase slope and weight parameters to produce the next partial weighted sum.

With the described embodiment of FIG. 5, if the number of component beams to generate is less than the number of calculators within a front-end unit, then the phases can be calculated for all the beams simultaneously. In certain embodiments, the outputs of the calculators 200 are cached in local memory allowing this calculator to be bypassed. In certain embodiments, the cached data is passed to the weighting using 214. In further embodiments when K>M, the calculators are time division multiplexed to calculate the phases for the component beams along with data from the local memory. This may result in speed improvements or energy efficiency improvements.

With the embodiment of FIG. 5, parallel processing is performed on all the phase slope and weight parameters received for the beams in the component beam directions in separate calculators in each of the front-end units. Processing is optimized by having separate calculators in parallel process the separate slope parameters to produce separate complex phasors for the different phase slope parameters. A separate unit may then simultaneously apply the weights to all the complex phasors to then combine into the final phase shift and gain values to provide to the mapper to generate the control signal. This hardware architecture allows for parallel processing of numerous component beams in each of the front-end units. Further, the computation in each front-end or IC are also computed in parallel control all the antennas in the phased array in parallel.

With described embodiment, a spatial filter may be selected that provides a subset of all possible component beams to the front-end units to reduce the amount of information transmitted to the front-end units. For instance, the number of beams for which slope and weight parameters are sent may be reduced to a single beam or a number of beams with a highest amplitude or other desired attribute, such as a cutoff for amplitudes. In this way, the set of transmitted phase slope and weight information is substantially reduced.

In yet further embodiments, the amount of information transmitted from the processor to the front-end units may be reduced by quantizing the beam space weights to send less information to the front-end units. In this way, the beam space weights are quantized into fewer bits of resolution to optimize transmission.

In yet further embodiments, the slope parameters sent by the processor may be reduced by sending the slope parameters for just one beam and allowing the front-end units to deduce the slope parameters for the other beams which are all equispaced with known spacing.

Still further, the buffer may cache calculations at different stages of computation, such as the calculated X-Y slope parameters modified by location information, the combined location weighted X-Y slope parameters, the weighted phasors, and the combined weighted phasors for later reuse if similar calculations are involved in subsequent spatial filters to process. This caching of calculations reduces computation time in the front-end units and optimizes the calculation of the final produced phase shit and gain parameters to send to the mapper.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of operating a phased array, comprising:
receiving, at front-end units, weights, and phase slope parameters for component beams; and
calculating, at a front-end unit of the front-end units, a phase shift and gain parameters for an antenna controlled by the front-end unit based on the phase slope parameters, the weights, and a physical location of the antenna controlled by the front-end unit.

2. The method of claim 1, further comprising:
determining the weights and phase slope parameters for component beams for a spatial filter.

3. The method of claim 2, further comprising:
determining a set of orthogonal directions for the spatial filter including a primary direction and orthogonal directions corresponding to the primary direction; and
sampling the spatial filter in the orthogonal directions to obtain the weights and the phase slope parameters.

4. The method of claim 3, further comprising:
determining a subset K of the component beams and corresponding K phase slope parameters and K weights; and
compressing the phase slope parameters and weights to send to the front-end units.

5. The method of claim 1, wherein the calculating the phase shift and the gain parameters for the front-end unit of the front-end units comprises:
calculating phase values from the phase slope parameters based on a physical location of the antenna controlled by the front-end unit;
calculating complex phasors corresponding to the phase values with a unit amplitude;
multiplying the complex phasors by the weights to produce weighted phasors; and
combining the weighted phasors to produce the phase shift and the gain parameters to control the antenna controlled by the front-end unit.

6. The method of claim 1, wherein the front-end unit includes M calculators, wherein there are K phase slope parameters and K weights for K component beams, where K<=M, and wherein the M calculators in parallel calculate M phase values from the M phase slope parameters and the physical location of the antenna controlled by the front-end unit.

7. The method of claim 1, wherein the front-end unit includes M calculators, wherein there are K phase slope parameters and K weights for K component beams, where K >M, and wherein the M calculators serially process sets of M or fewer phase slope parameters to calculate K phase values to sum.

8. The method of claim 7, wherein the calculating the phase shift and the gain parameters for the front-end unit of the front-end units comprises:
calculating up to M complex phasors from corresponding phase values with a unit amplitude;
multiplying the up to M complex phasors by weights to produce up to M weighted phasors;
combining the up to M weighted phasors with a previously calculated partial sum of weighted phasors to obtain a new sum of weighted phasors; and
buffering the new sum of weighted phasors.

9. The method of claim 1, wherein the phased array comprises a linear array of L antennas, with L-1 orthogonal beam directions with equispaced phase slope parameters.

10. The method of claim 1, wherein the phased array comprises an L*P element two dimensional array having (P-1)*(L-1) orthogonal beam directions with equispaced phase slopes in each dimension.

11. A phased array system, comprising:
a plurality of antennas;
a plurality of front-end units for controlling the antennas;
a spatial filter generator for:
determining weights and phase slope parameters for component beams; and
transmitting the weights and the phase slope parameters to front-end units controlling antennas; and
logic implemented in the front-end units, wherein the logic implemented in a front-end unit of the front-end units calculates a phase shift and gain parameters for an antenna controlled by the front-end unit based on the phase slope parameters, the weights, and a physical location of the antenna controlled by the front-end unit.

12. The phased array system of claim 11, wherein the spatial generator further performs:
determining a set of orthogonal directions for a spatial filter including a primary direction and orthogonal directions corresponding to the primary direction; and
sampling the spatial filter in the orthogonal directions to obtain the weights and the phase slope parameters.

13. The phased array system of claim 11, wherein the logic calculates the phase shift and the gain parameters by:
calculating phase values from the phase slope parameters based on a physical location of an antenna controlled by the front-end unit;
calculating complex phasors corresponding to the phase values with a unit amplitude;
multiplying the complex phasors by the weights to produce weighted phasors; and
combining the weighted phasors to produce the phase shift and the gain parameters to control the antenna controlled by the front-end unit.

14. The phased array system of claim 11, wherein the spatial generator further performs:
determining a subset K of the component beams and corresponding K phase slope parameters and K weights; and
compressing the phase slope parameters and weights to send to the front-end units.

15. The phased array system of claim 14, wherein the front-end unit includes M calculators, wherein there are K phase slope parameters and K weights for K component beams, where K<=M, and wherein the M calculators in parallel calculate M phase values from the M phase slope parameters and the physical location of the antenna controlled by the front-end unit.

16. The phased array system of claim 11, wherein the front-end unit includes M calculators, wherein there are K phase slope parameters and K weights for K component beams, where K>M, wherein the M calculators serially process sets of M or fewer phase slope parameters to calculate K phase values to sum, and wherein the calculating the phase shift and the gain parameters for the front-end unit of the front-end units comprises:
calculating up to M complex phasors from corresponding phase values with a unit amplitude;
multiplying the up to M complex phasors by weights to produce up to M weighted phasors;
combining the up to M weighted phasors with a previously calculated partial sum of weighted phasors to obtain a new sum of weighted phasors; and
buffering the new sum of weighted phasors.

17. An integrated circuit for controlling antennas in a phased array, comprising:
a plurality of front-end units for controlling the antennas;
logic implemented in the front-end units for receiving weights and phase slope parameters for component beams; and
logic implemented in a front-end unit of the front-end units for calculating a phase shift and gain parameters for an antenna controlled by the front-end unit based on the phase slope parameters, the weights, and a physical location of the antenna controlled by the front-end unit.

18. The integrated circuit of claim 17, wherein the logic calculates the phase shift and the gain parameters by:
calculating phase values from the phase slope parameters based on a physical location of an antenna controlled by the front-end unit;
calculating complex phasors corresponding to the phase values with a unit amplitude;
multiplying the complex phasors by the weights to produce weighted phasors; and
combining the weighted phasors to produce the phase shift and the gain parameters to control the antenna controlled by the front-end unit.

19. The integrated circuit of claim 17, wherein the front-end unit includes M calculators, wherein there are K phase slope parameters and K weights for K component beams, where K<=M, and wherein the M calculators in parallel calculate M phase values from the M phase slope parameters and the physical location of the antenna controlled by the front-end unit.

20. The integrated circuit of claim 17, wherein the front-end unit includes M calculators, wherein there are K phase slope parameters and K weights for K component beams, where K>M, and wherein the M calculators serially process sets of M or fewer phase slope parameters to calculate K phase values to sum.
